(19) United States
(12) Patent Application Publication
(10) Pub. No.: US 2013/0078544 A1
(43) Pub. Date: Mar. 28, 2013

(54) SYSTEM AND METHOD OF LEVERAGING THERMAL PROPERTIES OF FUEL CELL SYSTEMS AND CONSUMER DEVICES

(71) Applicant: ARDICA TECHNOLOGIES, INC., San Francisco, CA (US)

(72) Inventors: DANIEL BRAITHWAITE, SAN FRANCISCO, CA (US); TIBOR FABIAN, MOUNTAIN VIEW, CA (US)

(73) Assignee: ARDICA TECHNOLOGIES, INC., SAN FRANCISCO, CA (US)

(21) Appl. No.: 13/629,449

(22) Filed: Sep. 27, 2012

Related U.S. Application Data
(60) Provisional application No. 61/540,103, filed on Sep. 28, 2011.

(51) Int. Cl. H01M 8/04; H01M 16/00; H01M 8/24

(52) U.S. Cl. 429/442; 429/452; 429/458

(57) ABSTRACT

A fuel cell system for providing power to and leveraging waste heat from a consumer device, including a fuel cell stack that converts fuel to power at an operational temperature; a fuel source compartment that receives a fuel source that provides fuel to the fuel cell stack; an energy storage device; electrically connected to the fuel cell stack, that heats the fuel cell stack, receives power from the fuel cell stack, provides power to the device, and stores power from the fuel cell stack; and a thermal connection that directs waste heat from the device preferentially from the device to the fuel cell stack.

### CROSS-REFERENCE TO RELATED APPLICATIONS

This application claims the benefit of U.S. Provisional Application No. 61/540,103 filed 28 Sep. 2011, which is incorporated in its entirety by this reference. This application is related to U.S. patent application No. 13/286,052 filed 31 Oct. 2011, and U.S. patent application No. 13/565,409 filed 2 Aug. 2012, which are incorporated in their entirety by this reference.

### TECHNICAL FIELD

This invention relates generally to the fuel cell system field, and more specifically to a new and useful method of fuel cell system operation in the fuel cell system field.

### BACKGROUND

High temperature fuel cells are ideal for fuel cell applications, as they are highly efficient, have long-term stability, fuel flexibility, low emissions, and relatively low cost. However, the high operating temperatures of these fuel cells necessitate a large amount of energy input for startup and operation, which prevent high temperature fuel cell stacks from being used in commercial applications.

Additionally, solid fuel storage compositions (FSCs) are ideal for fuel cell applications, as they have relatively high energy densities. Endothermic fuel storage compositions, such as Mane, are particularly ideal for fuel generation, as they do not suffer from reaction runaway issues. However, endothermic FSCs also require a significant amount of energy input for initial warm-up and sustained fuel release, detracting from net energy output of the fuel cell system.

Whereas high temperature fuel cells and fuel storage compositions suffer from warm-up issues, energy consuming devices (particularly high-performance consumer devices) suffer from cooling issues, wherein the heat generated from device operation needs to be removed from the device to prevent device damage. Limitations on system heat removal may result in limitations on device performance. For example, many consumer devices are underclocked (operated at a lower clock rate) such that the device generates less heat, but at the cost of sacrificing performance.

Thus, there is a need in the fuel cell field to create a new and useful cooling energy generator and method of use.

### BRIEF DESCRIPTION OF THE FIGURES

FIG. 1 is a schematic representation of a fuel cell system for leveraging waste heat from a device.

FIG. 2 is a schematic representation of a first variation of the fuel cell system.

FIG. 3 is a schematic representation of an alternative of the first variation of the fuel cell system

FIG. 4 is a schematic representation of a specific embodiment of the first variation of the fuel cell system.

FIG. 5 is a schematic representation of a second variation of the fuel cell system.

FIG. 6 is a schematic representation of a method of fuel cell system operation.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

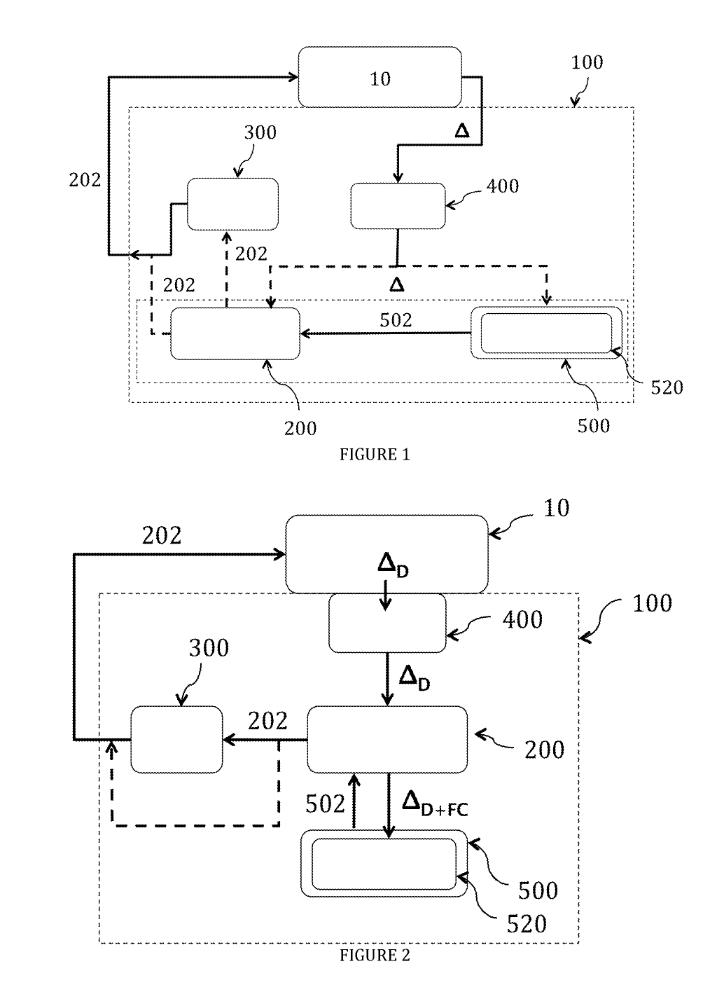

As shown in FIG. 1, the fuel cell system 100 for leveraging waste heat from a consumer device 10 includes a fuel cell stack 200, an energy storage device 300, and a thermal connection 400 configured to thermally couple to waste heat from the device 10 to the fuel cell stack 200. The fuel cell system 100 can additionally include a fuel source compartment 500 configured to receive a fuel source 520. The fuel cell system 100 functions to heat the fuel cell stack 200 with waste heat from the device 10 (Δ_{D}). As shown in FIG. 2, the fuel cell system 100 can additionally heat the fuel source 520 with waste heat from the device 10. By using the waste heat from the device 10 to heat or pre-heat the heat-intensive fuel cell system components, less energy input is required to raise the components to operational temperatures, and the fuel cell system 100 can function as a cooling system for the device 10.

Fuel cell system operation is preferably controlled by a processor, preferably the device processor in the manner described in U.S. application No. 13/286,052, incorporated herein in its entirety, but can alternatively be controlled by a separate processor. The fuel cell system 100 can additionally include a power connector that transfers electrical power out of the system. The fuel cell system 100 can additionally include an exhaust manifold that exhausts spent process air (e.g. process air with depleted oxygen), heated cooling fluid (e.g. from the fuel cell stack), excess hydrogen, or any other suitable exhaust fluid from the system.

The fuel cell system 100 preferably provides power 202 to an energy-consuming device 10, wherein the device 10 is preferably the device 10 from which the waste heat is provided, but can alternatively be a separate device. The device 10 is preferably a consumer device 10, more preferably a portable consumer device such as a laptop, cell phone, media player, or tablet, but may alternatively be any other suitable energy-consuming device. The device 10 preferably includes a processor, a battery, and a heat-generating component (e.g. a battery, CPU, RAM, graphics chip/card, etc.). The device 10 also preferably includes a cooling system, wherein the cooling system preferably includes a heat sink thermally coupled to the heat-generating component, and may include a heat transfer mechanism (e.g. a fan, heat pipe, Peltier element, etc.). The cooling system preferably moves heat out of the device 10 interior, either passively (e.g. conduction through the device casing, wherein the device 10 casing is conductive) or actively (e.g. blowing air over the heat sink out of vents in the device 10 casing).

The fuel cell system 100 preferably receives fuel 502 from a fuel source 520. The fuel source 520 is preferably a hydrogen fuel source 520, but can alternatively provide methane, propane, any other suitable hydrocarbon, or any other suitable fuel. The fuel source 520 is preferably a fuel generator that generates the fuel from a fuel precursor, but can alternatively be a fuel storage device 10, such as a pressurized canister of fuel. The fuel generator is preferably an endothermic fuel generator, but can alternatively be an exothermic fuel generator. The fuel generator preferably includes a fuel generating mechanism that reacts a fuel precursor to produce fuel. The fuel generator preferably thermolyses a fuel precursor to produce fuel, but can react the fuel precursor with a liquid reagent (e.g. hydrolysis), react the fuel precursor with a catalyst, or produce fuel through any other suitable means. The fuel generating mechanism can be one or more heating elements (e.g. resistive heaters), one or more thermally conductive elements, a pump, a catalyst, or any other suitable fuel generating mechanism. The fuel precursor is preferably a hydrogen storage composition, such as Mane (aluminum hydride, AlH₃, sodium borohydride, or any other suitable composition that adsorbs or chemically binds hydrogen. In one variation of the fuel cell system 100, the fuel source 520 includes an endothermic fuel generator that thermolyses the fuel precursor to produce fuel. In this variation, the endothermic fuel generator can include a generator heating element, wherein the generator heating element can be a resistive heater, a conductive element thermally connected one or more sections of the fuel precursor, or any other suitable heating element. In another variation of the fuel cell system 100, the fuel source 520 includes a fuel generator that hydrolyzes the fuel precursor to produce fuel. In this variation, the fuel generator preferably includes a liquid reagent reservoir, a pump that pumps the liquid reagent to the fuel precursor, and a biasing mechanism that biases unreacted liquid reagent toward a reaction front to which the liquid reagent is pumped. However, any suitable fuel generator can alternatively be used. The fuel source 520 is preferably the fuel precursor encapsulated within a casing, but can alternatively be solely the fuel precursor. The casing is preferably thermally insulated (e.g. with an insulator and/or vacuum insulation), but can alternatively be thermally conductive or be operable between the two states.

The fuel cell stack 200 of the fuel cell system 100 functions to convert fuel into electrical power. The fuel cell stack 200 preferably includes one or more fuel cells, wherein the fuel cells are preferably high temperature fuel cells, such as Polybenzimidazole (PBI) type, Nafion type, solid oxide fuel cells (SOFC), molten carbonate fuel cells (MCFCs), alkaline fuel cells, direct methanol fuel cells, phosphoric acid fuel cells, or any other suitable high temperature fuel cells. The fuel cells can alternatively be low temperature fuel cells, such as proton exchange membrane (PEM) fuel cells, or any other suitable fuel cell type. The fuel cells can be electrically connected in parallel or in series. The fuel cell stack 200 preferably includes a power outlet that allows electrical access to power produced by the fuel cell stack 200. The fuel cell stack 200 preferably includes a process air manifold that receives oxygen (e.g. from the ambient environment or another suitable oxygen source) and a fuel manifold that receives fuel. The cathodes of the fuel cell can be fluidly coupled in series or in parallel by the process air manifold, and the anodes of the fuel cells can be fluidly coupled in series or in parallel by the fuel manifold.

The fuel cell stack 200 can additionally include a fuel cell cooling mechanism that functions to cool the fuel cell stack 200. The cooling mechanism can be used to maintain the operational temperature of the fuel cells, and can additionally be used to cool the fuel cells below the operational temperature during system 100 shut down. The cooling mechanism can include a fluid channel encapsulating the fuel cell stack 200, wherein a pump or fan directs a cooling fluid, such as air, through the fluid channel over the fuel cell stack 200. The cooling mechanism can alternatively include a heat sink thermally connected to one or more of the fuel cells, wherein the heat sink can be cooled by convection. The cooling mechanism can alternatively be the device 10 cooling mechanism, wherein the device exhaust 20 can be at a low enough temperature to bring the fuel cell stack 200 below operational temperature. The cooling mechanism can alternatively be any suitable mechanism that cools the fuel cell stack 200. The cooling mechanism is preferably located within the system 100, but can alternatively be wholly or partially located within the device 10. The cooling mechanism preferably directs the heated cooling fluid to an exhaust manifold that exhausts the heated cooling fluid into a cooling fluid recovery system 100 or into the ambient environment.

The fuel cell stack 200 can additionally include a fuel cell heating mechanism that functions to heat the fuel cell stack 200. The heating mechanism can be used to heat the fuel cells up to the operational temperature. While fuel conversion into power is preferably exothermic such that steady state system 100 operation does not require additional fuel cell heating, the heating mechanism can be used to maintain the fuel cell operational temperature during steady state operation. The heating mechanism can be a resistive heating mechanism, thermally connected to one or more fuel cells, that uses electrical power to resistively heat the fuel cells. The heating mechanism can be a conductive heating mechanism that conducts heat from a heat source to the fuel cell stack 200. The heat source can be a resistive heat source, a chemical heat source (e.g. an exothermic chemical reaction), or any other suitable heat source. The heating mechanism is preferably located within the fuel cell system 100, but can alternatively be a portion of the device 10.

The energy storage device 300 of the fuel cell system 100 functions to store electrical energy. The energy storage device 300 can additionally function to store excess hydrogen (e.g. after device 10 removal) as electricity. The energy storage device 300 can additionally function as a capacitor that smoothes out the fuel cell power output. The energy storage device 300 can additionally provide electrical energy to the device 10. The energy storage device 300 can be electrically coupled to the power outlet of the fuel cell system 100 in series or in parallel. The energy storage device 300 can be electrically coupled to the fuel cell heating mechanism, wherein the fuel cell heating mechanism heats the fuel cell with power provided by the energy storage device 300. The energy storage device 300 can be electrically coupled to the fuel cell cooling mechanism, wherein the fuel cell cooling mechanism is powered by the energy storage device 300. The energy storage device 300 can additionally include a device power couple, configured to electrically couple to a device power inlet that transfers power to the device 10. The energy storage device 300 can be an adjustable load (e.g. have an adjustable resistivity), wherein the energy storage device 300 can additionally function to purge the system 100. A controller preferably controls the load, provided by the energy storage device 300, on the fuel cell system 100. However, the energy system 100 can alternatively have a non-adjustable resistivity. The energy storage device 300 is preferably a battery, more preferably a rechargeable battery, but alternatively any suitable energy storage device 300. The battery is preferably a lithium ion battery, but can be any other suitable battery. The battery can be the device battery, but can alternatively be a battery located within the fuel cell system 100, a battery located within the fuel storage, or an external battery.

The thermal connection 400 of the fuel cell system 100 functions to transfer heat from the device 10 to the fuel cell stack 200. More preferably, the thermal connection 400 functions as a thermal diode to preferentially direct heat from the device 10 to the fuel cell stack 200. The thermal connection 400 of the fuel cell system 100 can additionally transfer heat to a fuel storage compartment, wherein the fuel storage compartment holds the fuel source 520. The thermal connection 400 is preferably an integral component of the fuel cell system 100, but can alternatively be a separate component. The thermal connection 400 is preferably made of a conductive material, such as a metal (e.g. copper, aluminum, etc.) or a conductive polymer, but can alternatively be made from any suitable material. The thermal connection 400 can have a thermally insulated exterior, but can alternatively be uninsulated.

The thermal connection 400 can include a device interface 410 that functions to interface with the device 10. The device interface 410 can facilitate thermal coupling with the device exhaust 20, a heat generating device component, a heat-conducting device component, or any other suitable portion of the device 10 that can transfer waste heat. the device interface 410 can include a manifold that forms a substantially fluid impermeable seal with a device exhaust port 12 to channel device exhaust 20 into the thermal connection 400 (shown in FIG. 4), a thermal coupling to a heat-generating device component (e.g. the CPU, graphics card, etc.), a thermal coupling to a heat-conductive device component (e.g. the device power input, the device body or exterior, the device heat pipe or cold plate, etc.), or be any suitable interface that can couple to the device 10. The thermal coupling can be a dock that thermally couples to a broad face of the device body, a dock that couples to the device exhaust port, a dock that includes thermal connections that extend into the device body to connect to a thermally conductive component, a power connector that transfers power from the fuel cell system 100 to the device 10 and conducts heat from the device 10, or any other suitable device interface.

In one variation of the fuel cell system 100, the thermal connection 400 can be a fluid manifold that transfers heat from a fluid stream containing device waste heat to the fuel cell stack 200. The fluid stream containing device waste heat is preferably the device exhaust 20, but can be any suitable fluid stream. The fluid stream is preferably directed over the fuel cell stack 200 as a heating stream (e.g. within the cooling fluid channel), but can alternatively be provided into the process air manifold as process air, be provided into a channel or reservoir that is thermally coupled to but fluidly isolated from the fuel cell stack 200, or otherwise thermally coupled to the fuel cell stack 200. In this variation, the fluid manifold preferably includes a fluid moving mechanism that preferentially biases or moves the fluid stream from the device 10 toward the fuel cell stack 200. The fluid moving mechanism can be a fan, preferably the device fan but alternatively or additionally a secondary fuel cell system fan, a pump, or any other suitable fluid moving mechanism.

The fluid manifold can additionally include one or more conditioning modules that condition the fluid stream for introduction over or into the fuel cell stack 200. The conditioning module can be disposed across cross section of the thermal connection 400, along a surface of the thermal connection 400, or otherwise fluidly connected to the fluid stream. The conditioning module can include a particulate remover that removes particulates from the fluid stream (e.g. one or more filters, etc.), a moisture removal module (e.g. a desiccant bed, etc.).

The thermal connection 400 can additionally include a second fluid manifold 430 that transfers device waste heat to the fuel source compartment 500. This can be particularly desirable when the fuel source 520 is an endothermic fuel source 520. The second fluid manifold 430 is preferably thermally coupled to and fluidly isolated from the fuel source 520, but can alternatively be fluidly coupled to the fuel source 520. The second fluid manifold 430 can be fluidly connected to and receive a fluid stream from the fuel cell stack exhaust, the device interface 410 (e.g. wherein the device interface 410 is a fluid manifold that receives device exhaust 20), or any other suitable source of waste heat. In one alternative, the second fluid manifold 430 receives the fuel cell stack exhaust including heat from the device and heat from the fuel cell stack (Δ_{D+FC}). The second fluid manifold 430 can additionally be fluidly coupled to the exhaust manifold for the system.

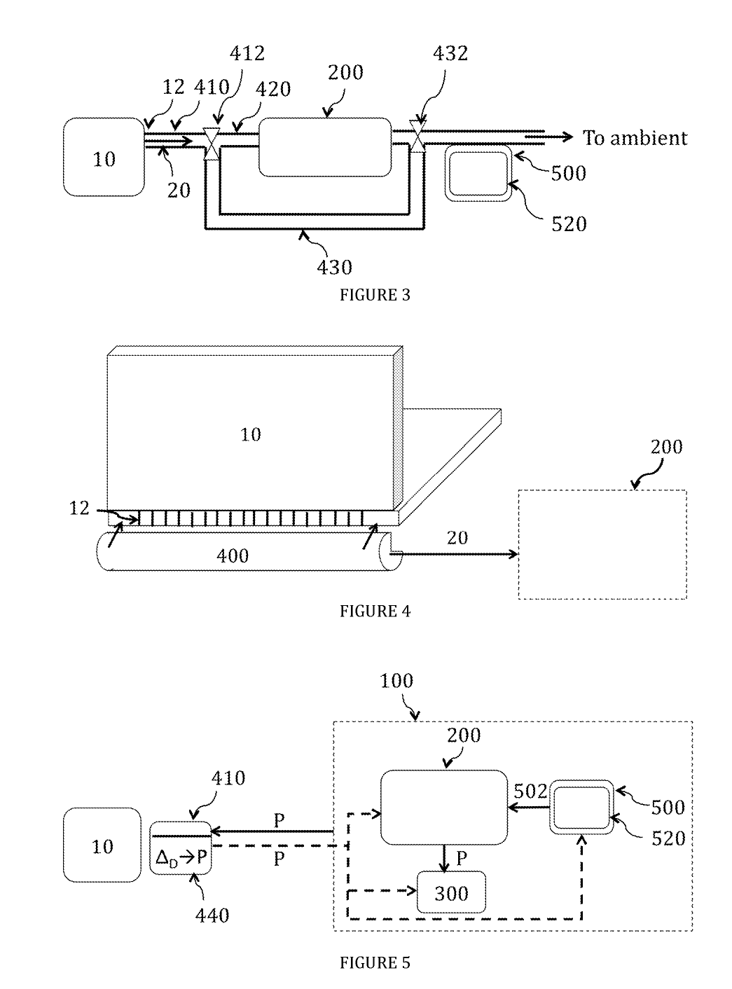

The thermal connection 400 can include one or more valves that control fluid flow through the system 100. The valves can be actively controlled (e.g. by a processor) or passively controlled (e.g. operate based on a temperature or pressure differential). The valves are preferably three-way valves, but can alternatively be two-way valves, one-way valves, or facilitate fluid transfer between any suitable number of possible fluid paths. As shown in FIG. 3, the valve can be located within the first fluid manifold 420, within the second fluid manifold 430, within the device interface 410, and/or within any suitable fluid path. In one variation, the thermal connection 400 includes a first valve 412 that can selectively fluidly connect the device interface 410 with the first fluid manifold 420, selectively fluidly connect the device interface 410 with the second fluid manifold 430, or selectively fluidly connect the device interface 410 with both the first and second manifolds 430. The thermal connection 400 can additionally include a second valve 432 that selectively fluidly connects the second fluid manifold 430 with the fuel cell stack exhaust. During system startup and/or steady state operation, the first valve 412 can direct a fluid stream from the device interface 410 to the fuel cell stack 200 and/or second fluid manifold 430, and the second valve 432 can direct the fluid stream (including the fluid stream from the device interface 410 and any additional cooling/heating streams) from the fuel cell stack 200 to the second fluid manifold 430. During system cool down, the first valve 412 can direct the fluid stream from the device interface 410 to the second fluid manifold 430, and the second valve 432 can seal the second fluid manifold 430 from the fuel cell stack 200. However, any suitable configuration, combination, and operation of the valves can be used.

In another variation of the fuel cell source, the thermal connection 400 can be a heat pump that preferentially pumps heat from the device interface 410 to the fuel cell stack 200. The heat pump is preferably thermally connected to the device interface 410 on a high temperature side and connected to the fuel cell stack 200 on a low temperature side. The heat pump is preferably driven by power from the energy storage device 300. The heat pump can be a thermoelectric heat pump (e.g. Peltier heater or cooler), or be any other suitable heat pump. The thermal connection 400 preferably additionally includes a disconnect mechanism that thermally disconnects the heat pump from the fuel cell stack 200 once the fuel cell stack 200 temperature exceeds the operational temperature differential limit of the heat pump, the device interface 410 temperature, or any other suitable disconnection condition. The disconnect mechanism can include an actively driven or passively driven (e.g. temperature dependent) ratchet that physically disconnects the heat pump from the fuel cell stack 200, a thermal couple between the heat pump and the fuel cell stack 200 that is operable between an insulating mode and a conducting mode (e.g. a gas-filled thermal connection 400, wherein gas removal, such as adsorption, switches the thermal couple into the insulating mode), a thermal switch located within the thermal path between the device interface 410 and the heat pump, or any other suitable disconnect mechanism.

In another variation of the fuel cell source, the thermal connection 400 can be a thermoelectric device 440 that converts a temperature difference between the device waste heat and a low-temperature source into electricity. The device waste heat can be provided from a heat-generating device component, a heat-conducting device component, the device exhaust 20, or any other suitable hot portion or product of the device 10. The low temperature source can be the ambient environment, a portion of the fuel cell system 100 that is thermally insulated from the fuel cell stack 200 and/or the fuel storage, or any other suitable low temperature source. The generated electricity can be stored in the energy storage device 300, be provided to the device 10, or used to heat the fuel cell stack 200 and/or the fuel storage. In a specific embodiment as shown in FIG. 5, the thermoelectric device 440 is preferably incorporated into the device interface 410 (e.g. a power connector), but can alternatively be thermally connected to the power connector and located along the power connection between the power connector and the fuel cell system, or located in any suitable position.

The fuel cell system 100 can additionally include a fuel source compartment 500 that receives a fuel source 520. The fuel cell system 100 is preferably configured to receive and heat an endothermic fuel source 520, but can alternatively receive an exothermic fuel source 520. The fuel source compartment 500 is preferably thermally coupled to the fuel cell stack 200, but can alternatively be thermally isolated from the fuel cell stack 200. The fuel source compartment interior is preferably fluidly isolated from the fuel cell stack 200, particularly from the fuel cell stack exhaust, but can alternatively be fluidly connected to the fuel cell stack 200. The fuel manifold of the fuel cell stack 200 preferably extends into the fuel source compartment 500, and preferably includes a fuel source interface that fluidly seals with the fuel source 520 to transfer fuel to the fuel cell stack 200. The fuel source compartment 500 preferably includes an electrical connection to power the fuel generating mechanism contained within the fuel source 520 (e.g. a pump, heater, etc.). Alternatively, the fuel source compartment 500 can include the fuel generating mechanism as well. The fuel source compartment 500 is preferably thermally insulated, but can alternatively be thermally conductive.

In one variation of the fuel cell system 100, the fuel cell system 100 heats the fuel cell stack 200 with the device exhaust 20. During system startup, the fuel cell stack 200 is preferably heated by the device exhaust 20. The fuel cell heating mechanism can additionally be used during system startup to bring the fuel cell stack 200 up to operating temperatures. During steady state operation and/or shutdown, the device exhaust 20 can be used as the cooling fluid to cool the fuel cell stack 200. The fuel cell system 100 includes a device interface 410 configured to substantially fluidly seal around the device exhaust port, a first manifold 420 fluidly connecting the device interface 410 to the cooling fluid inlet manifold of the fuel cell stack 200, and a second manifold 430 thermally connecting the cooling fluid exhaust manifold of the fuel cell stack 200 and the fuel storage compartment. In operation, device exhaust 20 is channeled by the device interface 410 through the first manifold 420, over and/or across the fuel cell stack 200, and through the second manifold 430 to heat the fuel storage.

In another variation of the fuel cell system 100, the fuel cell system 100 heats the fuel cell stack 200 and an endothermic fuel source 520 with the device exhaust 20. During system startup, the fuel cell stack 200 and the fuel source 520 are preferably heated by the device exhaust 20. The fuel cell heating mechanism and generator heating mechanism can additionally be used during system startup to bring the fuel cell stack 200 and fuel source 520 up to operating temperatures, respectively. During steady state operation, the device exhaust 20 can be used as the cooling fluid to cool the fuel cell stack 200, and is preferably fluidly sealed from the fuel source 520. During system 100 shutdown, the device exhaust 20 is preferably used to cool the fuel source 520 (e.g. directly thermally coupled to the fuel source 520), and is can additionally be used to cool the fuel cell stack 200. The fuel cell system 100 includes a device interface 410 configured to substantially fluidly seal around the device exhaust port, a first manifold 420 fluidly connecting the device interface 410 to the cooling fluid inlet manifold of the fuel cell stack 200, and a second manifold 430 thermally connecting the exhaust manifold of the fuel cell stack 200 and the fuel storage compartment. The second manifold 430 can additionally fluidly couple to the device interface 410. The second manifold 430 is preferably thermally coupled to but fluidly isolated from the fuel source compartment 500 interior, but can alternatively be thermally coupled to but fluidly isolated from the fuel source 520. The fuel cell system 100 preferably additionally includes a first valve 412 disposed between the device interface 410 and the second manifold 430 that controls fluid flow into the second manifold 430. The first valve 412 preferably fluidly connects the device interface 410, first manifold 420 and second manifold 430 during startup and shutdown, and blocks fluid flow from the device interface 410 into the second manifold 430 during steady state operation. The fuel cell system 100 preferably additionally includes a second valve 432 disposed between the exhaust manifold of the fuel cell stack 200 and the second manifold 430 that controls fluid flow from the fuel cell stack 200 into the second manifold 430. The second valve 432 preferably permits fluid flow from the exhaust manifold into the second manifold 430 during system startup and steady state operation, and prevents fluid flow from the exhaust manifold into the second manifold 430 during shutdown.

In another variation of the fuel cell system 100, the fuel cell system 100 heats the fuel cell stack 200 and/or the fuel storage with the waste heat conducted from a heated device component. The fuel cell system 100 includes a device interface 410 that thermally connects to a heat-conducting device component, a thermoelectric generator that is thermally connected to the device interface 410, and a low temperature source that is configured to convert the temperature difference between the device interface 410 and the low temperature source into electrical power. The electrical power is preferably stored within the energy storage device 300, wherein the energy storage device 300 is preferably thermally insulated from the fuel cell stack 200. The electrical power can be used to power the fuel cell heating mechanism(s), or can be provided to the device 10. The thermoelectric generator is preferably incorporated into the device interface 410. The device interface 410 is preferably a power connector, wherein the power connector provides power from the energy storage device 300 to the device 10, is thermally coupled to the power input of the device 10, and is thermally coupled to the ambient environment as the low temperature source. The power connector can additionally include a second power line that transfers generated power back to the energy storage device 300.

As a person skilled in the art will recognize from the previous detailed description and from the figures and claims, modifications and changes can be made to the preferred embodiments of the invention without departing from the scope of this invention defined in the following claims.

2. Method of Heating an Energy Generator

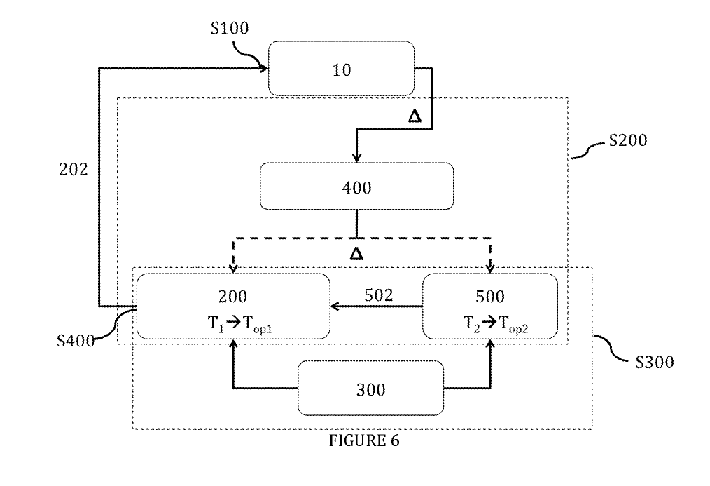

As shown in FIG. 6, the method of heating an energy generator with waste heat from a consumer device includes detecting a requirement for power S100, heating an energy generator component with waste heat from the device S200, heating the component to an operational temperature S300, and providing power to a consumer device S400. The method can additionally include cooling the energy generator component with a cooling fluid from the device during energy generation and cooling a rate-limiting energy generator component with the cooling fluid upon determination of a stop condition. This method functions to leverage waste heat from a device to heat or pre-heat energy generator components having operational temperatures over ambient. This method can additionally function to leverage the cooling stream from the device to cool endothermic components of the energy generator, thus reducing the amount of additional cooling that needs to be provided by the energy generator. This can have the benefits of potentially reducing the amount of energy required to cool the energy generator and/or reducing the profile and size of the energy generator.

The method is preferably performed by the energy generator, and is preferably controlled by a controller. The controller is preferably that of the device, but can alternatively be a separate controller contained within the energy generator. However, the method can be controlled by passive components within the energy generator. The energy generator is preferably the system as described above, but can alternatively be any fuel cell system including a fuel cell stack that converts fuel into electrical power, a fuel source compartment that receives a fuel source, and a battery that stores the generated power and/or provides power to heat and/or cool the fuel cell stack and/or fuel source. The fuel source is preferably a fuel generator, more preferably an endothermic fuel generator that thermolyses a fuel precursor into fuel. For example, the fuel can be hydrogen gas, wherein the fuel precursor can be Alane.

Detecting a requirement for power S100 functions to signal that the energy generator should initiate the energy generation process. Detecting a requirement for power can additionally function to signal that fuel should be generated, if a fuel generator is used. Detecting a requirement for power can include receiving a digital signal from the device, detecting a power draw from the device, detecting battery drainage, detecting coupling between a device and the energy generator (e.g. mechanically or electrically, such as the completion of a circuit), or any other suitable method of detecting a requirement for power provision. Detecting a requirement for power can additionally and/or alternatively include receiving a signal from a user, such detecting an electrical coupling of the energy generator to the device or detecting an actuation of a button.

Detecting a requirement for power can additionally include detecting the device temperature, or determining that the device is producing heat over a predetermined heat threshold, which functions to notify the processor whether there is enough waste heat to heat the energy generator components. Detecting the device temperature preferably includes receiving a signal indicative of temperature from an sensor connected to an energy generator component (e.g. the device interface) that is thermally coupled to a heat-conductive portion of the device, but can include receiving the heat output(s) of the device components from the heat-monitoring module of the device or any other suitable method of determining the device heat output. Determining that the device is producing heat over a predetermined heat threshold can additionally include determining the amount of heat produced, wherein the amount of heat produced can be measured or calculated from temperature flux, cooling fluid flow rate, or any other suitable measurement using any suitable measurement device (e.g. temperature sensor, flow sensor, Peltier device, etc.).

Heating an energy generator component with waste heat from the device S200 functions to utilize the waste heat from the device to at least partially heat the energy generator components, such that less subsequent energy is needed to heat the energy generator components to operational temperatures. Waste heat can be wholly or partially directed to the fuel cell stack, the fuel source, or simultaneously directed to both the fuel cell stack and the fuel source. Heating the energy generator component with waste heat is preferably performed when the device is detected to provide more heat than a heat threshold. The heat threshold is preferably set near the point at which the amount of energy transferred from the device to the energy generator components exceeds the amount of energy required to perform the transfer. Alternatively, heating the energy generator component with waste heat can be initiated as a default (e.g. whenever the device is running, whenever the device produces heat, etc.), or initiated in response to any suitable initiation criteria. When the device produces less heat than the heat threshold (e.g. when the device is off), the battery of the fuel cell system is preferably used to heat the energy generator components up to operational temperature, wherein heat from the device preferably supplements component heating as the heat is generated.

In a first variation, heating an energy generator component includes directing a cooling fluid containing device waste heat (e.g. a device exhaust stream) to the energy generator component. Heat can be directed to the air inlet of a fuel cell within the fuel cell stack (e.g. the first fuel cell in oxygen-receiving order), to a plurality of fuel cells (e.g. wherein the cooling fluid is directed over the entire fuel cell stack in a similar manner to fuel cell stack cooling), to the fuel cell stack then to the fuel source, to the fuel cell stack and the fuel source substantially simultaneously (e.g. by splitting the exhaust stream), or any other suitable exhaust flow path. Heating an energy generator component can additionally include filtering the device exhaust and/or desiccating the device exhaust prior to introduction to the energy generator component.

In a second variation, heating an energy generator component includes pumping heat from a device interface, thermally coupled to the device, to the energy generator component. This is preferably accomplished by a heat pump, which also preferably prevents heat leakage from the device to an energy generator component.

In a third variation, heating an energy generator component includes extracting electricity from a temperature difference between the device interface and a low-temperature source. The low temperature source is preferably the ambient environment, but can alternatively be a portion of the fuel cell system that is thermally insulated from the heated components or any other low temperature source. Heating an energy generator component can additionally include storing the extracted electricity in the battery, heating the energy generator component with the extracted electricity, providing the extracted electricity back to the device, or any other suitable means of utilizing the extracted electricity.

Heating the component to an operational temperature S300 functions to heat the energy generator component to the operational temperature, such that the component can begin functioning and the energy generator may begin generating electricity. This is preferably performed by a processor that controls the amount of energy provided by a battery to a heating element coupled to the energy generator component. However, any other suitable heating mechanism may be utilized. The energy generator components to be heated include at least one fuel cell of the fuel cell stack and at least a portion of the fuel source. Heating the component to an operational temperature preferably includes measuring a parameter of the energy generator component, and providing energy until the parameter meets a given criteria. More preferably, heating the component to an operational temperature includes measuring the temperature of a fuel cell and providing energy until the temperature of the fuel cell meets or exceeds a predetermined temperature threshold (preferably the operational temperature, but alternatively a lower or higher temperature). However, these steps may additionally/alternatively include measuring the temperature of a portion of the fuel source and providing energy until the temperature of the segment meets or exceeds a predetermined temperature threshold (preferably the operational temperature, but alternatively a lower or higher temperature). However, any suitable energy generator component parameter and given criteria may be used. The heated fuel cell and/or fuel storage composition segment are preferably the same fuel cell and/or fuel storage composition segment that was pre-heated by the waste heat from the device, but may alternatively be different fuel cell(s) and/or segment(s).

Providing power to a consumer device S400 functions to power the device. Providing power to a device preferably includes generating fuel from the fuel source, converting the fuel into electrical power by the fuel cell stack, and providing the generated power to the device. Generating fuel from the fuel source preferably includes endothermically generating fuel by thermolysing a fuel precursor, but can alternatively include reacting a fuel precursor with a liquid reagent to generate fuel (e.g. through hydrolysis), or any other suitable means of generating fuel. Generating fuel from the fuel source can additionally include heating the fuel source with exhaust from the fuel cell stack. Since the fuel cell stack can run at temperatures higher than the thermolysis temperature of the fuel precursor, is exothermic in operation, and requires cooling, energy can be conserved by thermally coupling the fuel cell stack exhaust to the fuel source, reducing heating energy for the fuel source and cooling energy for the fuel cell stack. Converting the fuel into power by the fuel cell stack preferably includes providing the fuel and oxygen to the fuel cells. Providing the generated power to the device can include directly providing the power to the device or storing the power in the battery, wherein the battery provides the power to the device.

Cooling the energy generator component with a cooling fluid from the device during energy generation functions to leverage the relatively lower-temperature device exhaust to cool the energy generator components that require cooling during steady state operation. Furthermore, cooling the energy generator component with the cooling stream from the device (e.g. device exhaust) can reduce the amount of additional power spent on component cooling. For example, the fuel cell stack must be cooled during steady state operation; typically, a fan is used to introduce a cooling fluid (e.g. ambient air) over the fuel cell stack. However, the device exhaust can be used in lieu or in addition to the fuel cell stack cooling mechanism to cool the fuel cell stack, since the device exhaust is at a much lower temperature than fuel cell stack operation. The energy generator component cooled is preferably the fuel cell stack, wherein the device exhaust is preferably directed over and/or through the fuel cell stack, but can alternatively be the fuel source, wherein the device exhaust is preferably thermally coupled to but fluidly isolated from the fuel source.

Cooling a rate-limiting energy generator component with the cooling fluid upon determination of a stop condition functions to cease energy generation. Cooling the rate-limiting component preferably includes cooling the rate-limiting component with the device exhaust, which functions to leverage the relatively lower temperature device exhaust to shut down the energy generator. The rate-limiting component is preferably the component that restricts the overall energy generation rate. The rate-limiting component can be the fuel cell stack, but can alternatively be the fuel source, particularly when the fuel source is a fuel generator. Cooling the rate-limiting component preferably includes placing a cooling fluid having a lower temperature in thermal contact with the rate-limiting component. Cooling the rate-limiting component can include redirecting the device exhaust from the fuel cell stack to the fuel source, directing a portion of the device exhaust to the fuel source, directing ambient air to the fuel source, or any other suitable method of cooling the rate-limiting component.

The method can additionally include sending a signal to the device to improve performance. The increase in device performance preferably results in higher device energy consumption, preferably resulting in increased device heating, allowing for more heat to be provided to the energy generator component. Providing more heat to the energy generator component can result in an increase in power output, particularly if the heat is used to heat the fuel storage composition, which may accommodate for the increased power requirements of the higher performing device. This is due to the positive correlation between temperature and fuel storage composition decomposition; the higher the temperature, the faster the fuel storage composition decomposes and the faster fuel is produced. Alternatively, to accommodate the higher voltages required by the higher performing device, the step of improving device performance might be paired with the step of reconfiguring the electrical configuration of the fuel cell system to increase the output voltage of the energy generator. The step of signaling for improved device performance is preferably accomplished over a data connection between the energy generator and the device, but can alternatively be accomplished by the device processor, wherein the device processor detects that the device is coupled to a cooling energy generator. This detection preferably includes processor detection of a unique identifier for the energy generator, wherein the identifier is preferably an electrical identifier (e.g. the energy generator has a given inductance, completes a unique circuit of the device, provides a unique power pattern upon startup [e.g. power is provided for a given duration, shut off for a given duration, then turned back on again], etc.), but may alternatively be a magnetic identifier, an RF identifier, a Bluetooth identifier, a mechanical identifier, or any other suitable identifier.

As a person skilled in the art will recognize from the previous detailed description and from the figures and claims, modifications and changes can be made to the preferred embodiments of the invention without departing from the scope of this invention defined in the following claims.

We claim:

1. A fuel cell system for providing power to and leveraging waste heat from a consumer device, comprising:
a device interface that thermally couples to waste heat from the device;
a fuel cell stack;
an energy storage device, electrically connected to the fuel cell stack, that heats the fuel cell stack, receives power from the fuel cell stack, provides power to the device, and stores power from the fuel cell stack; and
a thermal connection that directs heat preferentially from the device interface to the fuel cell stack.

2. The fuel cell system of claim 1, wherein the energy storage device comprises an adjustable load.

3. The fuel cell system of claim 1, wherein the thermal connection comprises a manifold fluidly connected to the fuel cell stack and fluidly connects to a device exhaust port, wherein the manifold directs device exhaust over the fuel cell stack.

4. The fuel cell system of claim 3, wherein the fuel cell system comprises a fuel source compartment and the thermal connection further comprises a second manifold thermally coupled to and fluidly isolated from the fuel source compartment, wherein the second manifold is fluidly connected to the device exhaust port.

5. The fuel cell system of claim 4, wherein the thermal connection further comprises a valve operable between:
a first position that directs device exhaust flow into the first manifold and prevents direct device exhaust flow into the second manifold;
a second position that directs device exhaust flow into the second manifold and prevents device exhaust flow into the first manifold.

6. The method of claim 5, wherein the second manifold is fluidly connected to the fuel cell stack and receives fuel cell stack exhaust.

7. The fuel cell system of claim 1, wherein the thermal connection comprises a thermoelectric generator, electrically connected to the energy storage device, that generates power from a temperature differential between a thermally conductive device component and a low temperature source.

8. The fuel cell system of claim 7, wherein the thermal connection comprises a power interface configured to electrically couple the fuel cell stack with the device, wherein the thermoelectric generator thermally connects to a thermally conductive portion of a device power input.

9. The fuel cell system of claim 7, wherein the low temperature source is air from the ambient environment.

10. A fuel cell system for providing power to and leveraging waste heat from a consumer device, comprising:
a high temperature fuel cell stack;
a fuel source compartment configured to receive an endothermic fuel generator;
a first manifold configured to accept and direct device exhaust over the fuel cell stack, wherein the first manifold is fluidly connected to the fuel cell stack and configured to be fluidly connected to an exhaust port of the device;
a second manifold, fluidly isolated from and thermally coupled to the fuel source compartment, configured to heat a portion of the fuel source compartment with heat from the device exhaust.

11. The fuel cell system of claim 10, further comprising a valve located within the first manifold, the valve operable in:
a first state, wherein the valve fluidly connects the device exhaust with the fuel cell stack and fluidly connects the device exhaust with the second manifold;
a second state, wherein the valve fluidly connects the device exhaust with the fuel cell stack and fluidly seals the device exhaust from the second manifold.

12. The fuel cell system of claim 11, wherein the second manifold is fluidly connected to the fuel cell stack and receives the device exhaust downstream from the fuel cell stack.

13. The fuel cell system of claim 12, further comprising a second valve located within the second manifold, the second valve operable in:
a first state, wherein the second valve fluidly connects the fuel cell stack with the second manifold; and
a second state, wherein the second valve fluidly seals the fuel cell stack from the second manifold.

14. The fuel cell system of claim 13, further comprising a control mechanism configured to switch the first and second valves between the respective first and second states in response to an energy demand from the device and the fuel cell stack temperature, wherein the control mechanism places:
the first valve in the first state and the second valve in the first state when the energy demand is above a demand threshold and the fuel cell stack temperature is below a temperature threshold;
the first valve in the second state and the second valve in the first state when the energy demand is above the demand threshold and the fuel cell stack temperature is above the temperature threshold; and
the first valve in the first state and the second valve in the second state when the energy demand is below the demand threshold and the fuel cell stack temperature is above the temperature threshold.

15. The fuel cell system of claim 14, wherein the control mechanism is controlled by a device processor.

16. The fuel cell system of claim 15, wherein the control mechanism includes a data connection to the device interface, wherein the control mechanism receives directions from the device processor through the device interface.

17. A fuel cell system for providing power to and leveraging waste heat from a consumer device, comprising:
a high temperature fuel cell stack configured to provide electrical power to the device;
an energy storage device electrically connected to and configured to heat the high temperature fuel cell stack with electrical power;
an insulation mechanism configured to substantially thermally insulate the energy storage device from the high temperature fuel stack;
a device interface configured to thermally couple to a heat-conducting portion of the device;
a thermoelectric generator, electrically connected to the energy storage device and thermally connected to the device interface and a low-temperature source, configured to convert the temperature difference between the device interface and the low-temperature source into electrical power.

18. The fuel cell system of claim 17, wherein the device interface comprises a power provision interface configured to electrically connect to a device power input.

19. The fuel cell system of claim 18, wherein the power provision interface further comprises a wire electrically connected to a power output of the fuel cell stack.

20. The fuel cell system of claim 19, wherein the power provision interface includes the thermoelectric generator, wherein the wire further includes a second electrical path electrically connecting the thermoelectric generator to the energy storage device.
